(19) United States
(12) Patent Application Publication
(10) Pub. No.: US 2007/0276514 A1
(43) Pub. Date: Nov. 29, 2007

(54) Method In A Safety System For Controlling A Process Or Equipment

(75) Inventors: Robert Martinez, Asker (NO); Per Juel, Drammen (NO); Per Fjelldalen, Oslo (NO)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 10/584,213

(22) PCT Filed: Dec. 17, 2004
(86) PCT No.: PCT/IB04/04177

§ 371 Date: May 8, 2007

(30) Foreign Application Priority Data
Dec. 23, 2003 (SE) 0303577-1

(51) Int. Cl. G05B 9/02

(52) U.S. Cl. 700/80

(57) ABSTRACT

A method in an industrial safety system for controlling a process or equipment. The industrial safety system including components with safety devices. The safety system enables signals to be generated as a result of an event or alarm. An automated link is created between the event or alarm and an action to be taken upon receipt of the event or alarm signal due to the event. A control signal is generated to initiate the action. Also, a computerized system according to the method.

### TECHNICAL FIELD

A method in an industrial safety system for controlling a process or equipment, which industrial safety system comprises components with inputs and safety devices, that enables signals to be generated as a result of an event or alarm, wherein an event or alarm causes a signal to be generated. A method for handling events in an industrial system, such as alarms. A method for enabling an action according to an event in an industrial system, such as an alarm or other events.

### BACKGROUND ART

An industrial process has a physical implementation comprising components such as devices and apparatuses for operation, control, regulation and protection of the process. The industrial process also comprises systems for functionality, control and supervision. This results in a complex combination of system and components. In such an industrial process it is necessary to protect the process or an environment individual, systems subsystems and/or components. As part of the functions of the elements in the system, measurements on parameters such as currents, voltages, phases, temperatures and so on are made substantially continuously and may result in different safety events, including even a plant shut-down. The safety-related functions of the industrial system are performed by a safety system with input from safety devices. Safety systems have been developed for the purpose of enabling action of reactions to the safety events. Safety systems in industry have a general criterion of engineering with strong emphasis on quality and verification. Such systems are typically not fully standardised but are often purpose-built and usually include devices and/or subsystems, software and communication protocols.

A safety system must perform very reliably, even more reliably than the control systems they protect; this means that a different standard of engineering must be used, with stronger emphasis on quality and verification. Current engineering toolsets do not have a safety emphasis as a first priority. They instead prioritise features and flexibility. Higher quality control systems can be achieved by minimising the manual coding effort, which is the largest single sources of computer bugs, such as incorrect programming code. This approach is especially important if the customer is seeking Safety Integrity Level (SIL) classification of their safety system that is according to the standards; IEC-91508 Functional safety of electrical/electronic/programmable electronic safety-related systems, IEC/TR3 91510 RMBK nuclear reactors—Proposals for instrumentation and control, IEC-61511 Functional safety—Safety instrumented systems for the process industry sector.

U.S. Pat. No. 5,361,198 describes a concept including a safety system, comprising software, displays for input, a general safety system and hand-coded functions. Some specialized safety engineering tools exist, but these demand verification and hand-coded functions.

However, secure safety control code is compromised if there is a bug in the hand-coded function, such as an operator display, which gives a wrong indication. The operator may take action when none was required, or vice versa.

### SUMMARY OF THE INVENTION

The aim of the present invention is to remedy one or more of the above mentioned problems.

A method in an industrial safety system for controlling a process or equipment, which industrial safety system comprises components with safety devices. The control system enables signals to be generated as a result of an event or alarm. An automated link between the event or alarm and an action to be taken upon receipt of said event or alarm signal due to the event is created. A control signal to initiate the action is generated.

The major advantage of the invention is that an auto-generation of the Human machine interface (HMI) in parallel with auto-generation of control code makes safety systems more reliable since it reduces the chance of introducing human error in design.

Another advantage of the invention is that the resulting complete safety system can be more fully tested earlier in the product development cycle.

Yet another advantage of the invention is that the resulting complete safety system is created in a more cost-effective, work-effective and timesaving manner.

Safety engineering tools that can generate control system software automatically offer better quality for this reason and are also inherently verified.

The system may be implemented as a server function, wherein the safety system is created and recreated thousands of times on hundreds of objects.

In another aspect of the invention, a method is described for an auto-generation of the HMI (Human machine interface) dependent on auto-generation of control code. The method includes use of the human-machine interface of the invention comprising information displayed by the visual display and use of the display, and generation means to generate the operator display.

In another aspect of the invention, a computer program is described for carrying out the methods according to the invention. In another aspect of the invention a computer program product comprising a computer program for carrying out the method of the invention is described. In another aspect of the invention, a computer data signal embodied in a carrier wave is described. In another, further aspect of the invention, a graphical user interface is described for displaying safety data for the one or more of the apparatuses so protected.

With a preferred embodiment of the invention the operator gains an online view of the safety system. Also provided by the invention is an automatic up-dating of the HMI according to the invention.

In another a preferred embodiment of the invention a representation of a safety device is configured, and configuring a representation of said event or alarm is configured.

In another a preferred embodiment of the invention a schematic representation of the safety system comprising the components and the safety devices and a representation of each component is created.

In another a preferred embodiment of the invention a representation of each safety device is created.

In another a preferred embodiment of the invention a representation of each input and a representation of each output is created.

In another a preferred embodiment of the invention a representation of each action and a representation of each event is created.

In another a preferred embodiment of the invention one or more links comprising a link between the event and the input, comprising a path between the input and the safety device, a path between the safety device and output, and a path between the output and the action is configured.

In another a preferred embodiment of the invention the link is displayed by means of a representation in an HMI.

In another a preferred embodiment of the invention the link is displayed by means of a representation in a graphical user interface on a screen.

In another a preferred embodiment of the invention each path is represented by a table.

In another a preferred embodiment of the invention each table is displayed in a graphical user interface on a screen.

In another a preferred embodiment of the invention relations between the representations are displayed in the form of a matrix.

In another a preferred embodiment of the invention a graphical user interface is used for controlling a process or equipment in an industrial safety system, which industrial safety system comprises components with safety devices, that enable signals to be generated as a result of an event or alarm. The graphical user interface comprises: display means to display a representation of an item, display means to display relations between the items, and input means to register said items and relations.

In another a preferred embodiment of the invention a graphical user interface comprises: input means to register an alarm signal or an event, and input means to register an input to a safety device

In another preferred embodiment of the invention a graphical user interface comprising: display means to register an input signal, and display means to register an output signal

In another preferred embodiment of the invention a graphical user interface comprises input means to register a path.

In another preferred embodiment of the invention a graphical user interface comprises display means for creating a matrix.

The HMI according to the invention may also function as an editor.

### BRIEF DESCRIPTION OF THE DRAWINGS

The present invention will be described in more detail in connection with the enclosed schematic drawings wherein:

FIG. 1 shows elements of an industrial control system in a simplified block diagram,

FIG. 2 shows a preferred embodiment of a safety display,

FIG. 3 shows graphical user interfaces by which safety data are saved according to the invention,

FIG. 4 shows elements of a safety system in a simplified block diagram,

FIG. 5a shows a meta-loop in a safety system in a simplified block diagram,

FIG. 5b shows a detailed loop in a safety system in a simplified block diagram,

FIG. 6 shows in a schematic way how one device or more devices are connected via a fieldbus network of a safety system,

FIG. 7 shows a meta-method to create an safety system according to the invention and

FIG. 8 shows a detailed method to create a safety system according to the invention.

### DESCRIPTION OF THE PREFERRED EMBODIMENTS

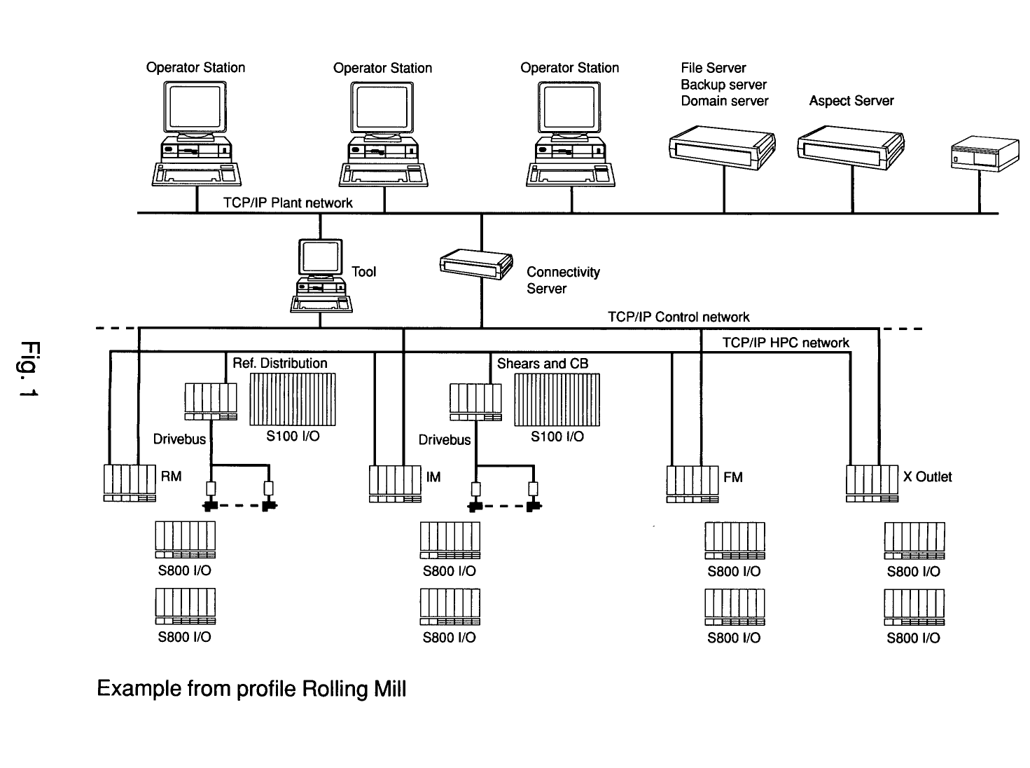

FIG. 1 shows elements of an industrial control system in a simplified block diagram. The safety system is comprised in the control system or functions as an individual system in parallel with the control system, sometimes even enabling the same action, but with different decision chains.

The construction of the safety system structure is not unlike a tic-tac-toe game. Every object has a predefined relation to all other objects. The method involves auto-generating a Human machine interface (HMI) in parallel with autogeneration of a control code. The safety system generates atomically the graphical object for the operator displays, which exposes the entire underlying object's functionality, such as access to data, start/stop or another functions. These graphical objects are automatically arranged on the display to reflect the arrangement in the safety program.

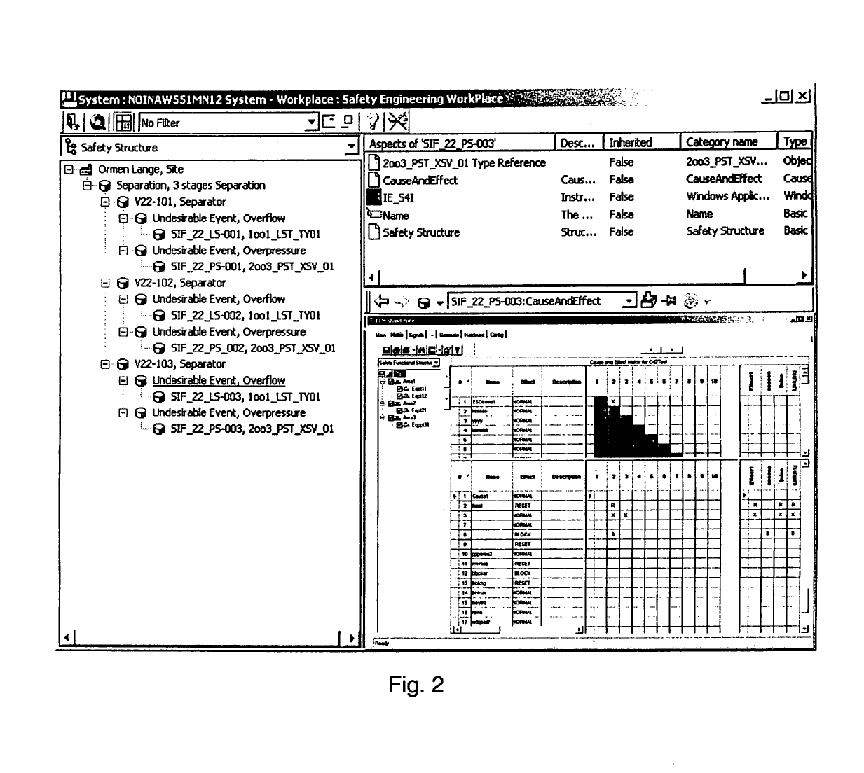

FIG. 2 shows a preferred embodiment of a safety display. The display is associated with selection means for input etc. as shown as buttons in this example. The structure of the system is to create a grid/matrix of related objects. The grid/matrix is a system of rows and columns. Each square is an underlying grid/matrix until the last level. On the first level the rows comprise information that displays facts such as causes like overpressure. Columns display levels, such as a plant shutdown. One column link to the cause a certain row can, for example, cause a shutdown action. A marking in the grid/matrix may be a marking for one or several columns.

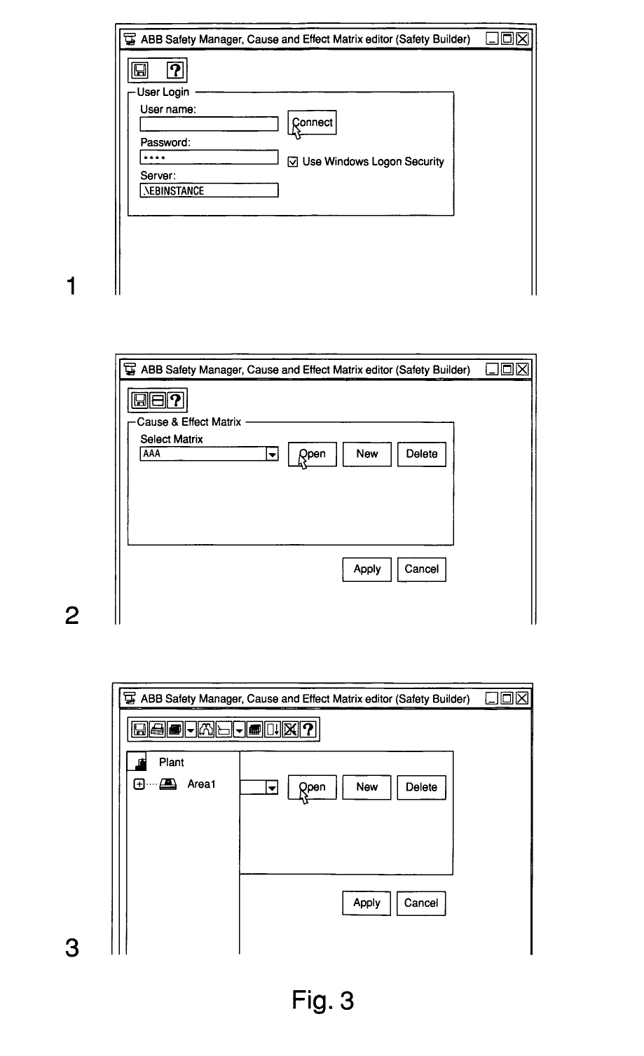

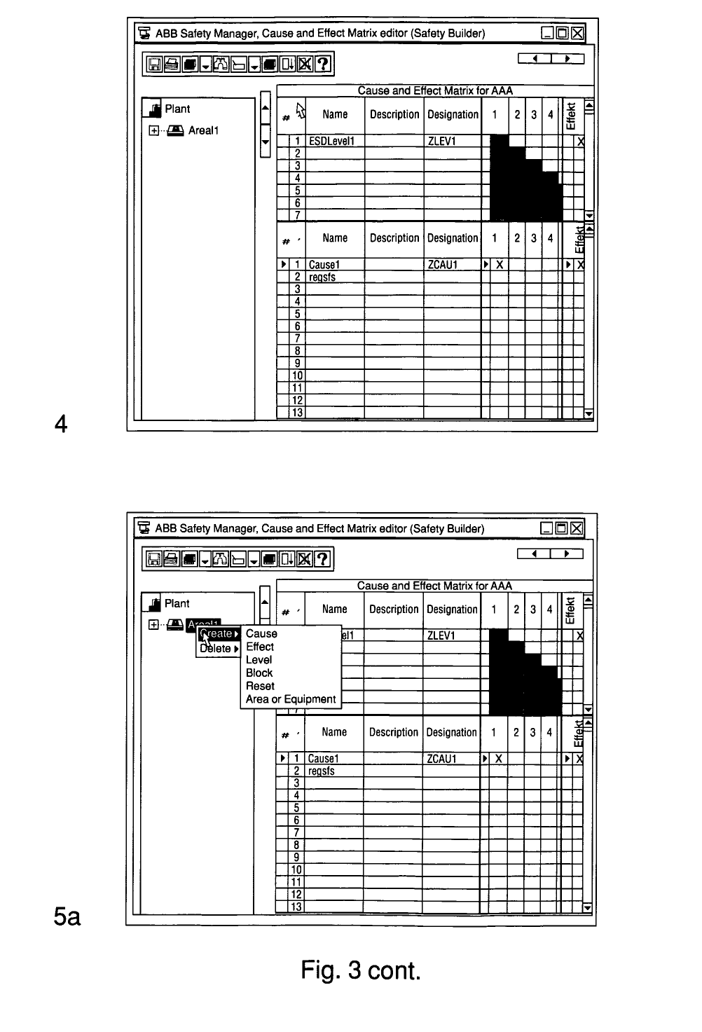

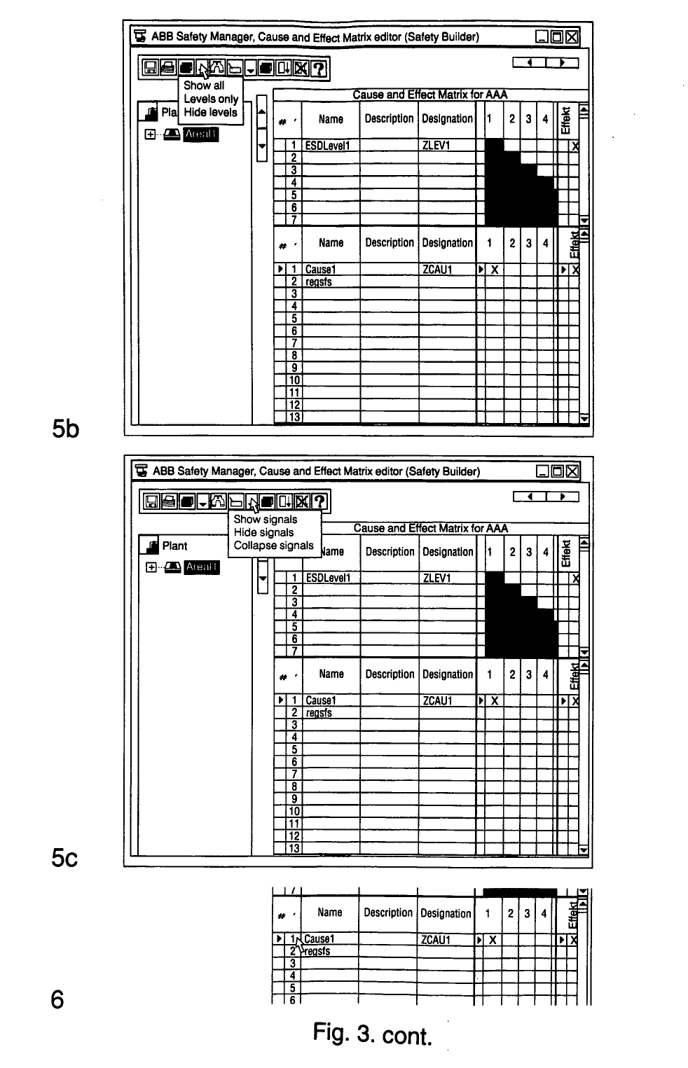

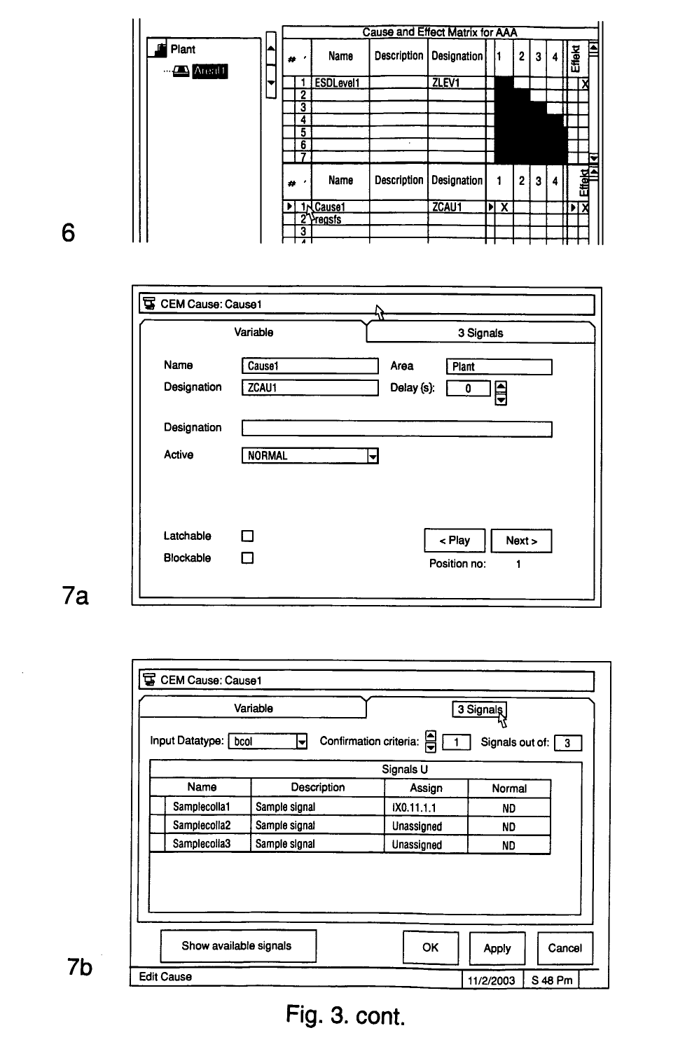

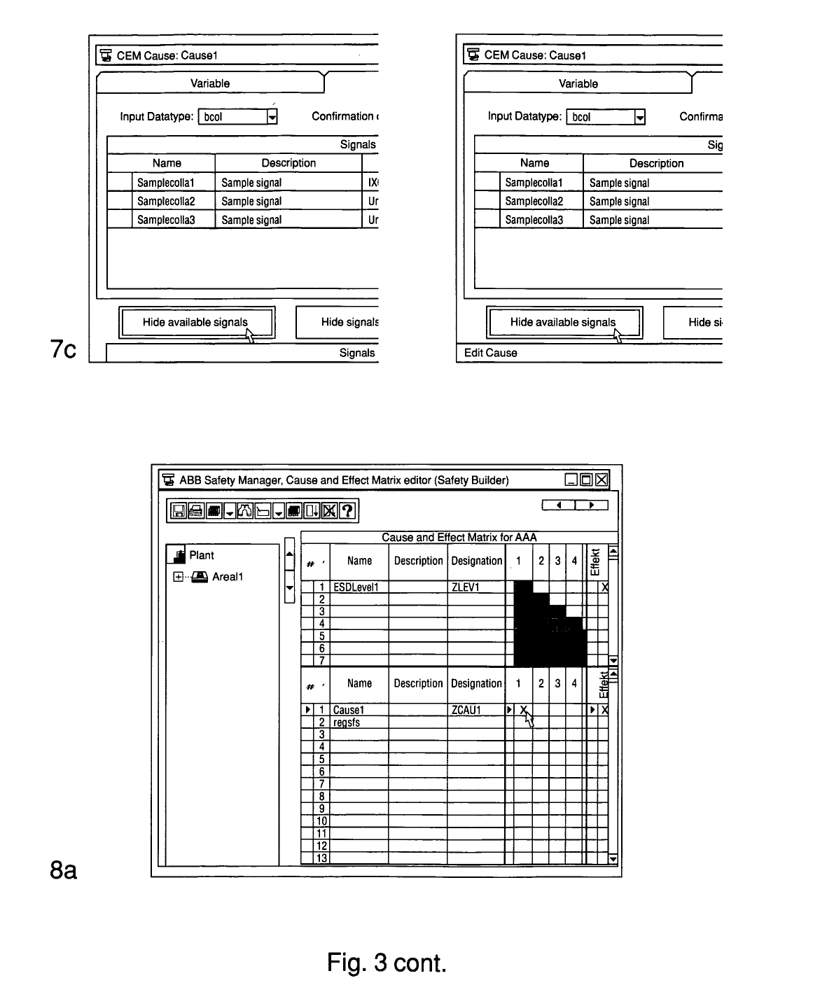

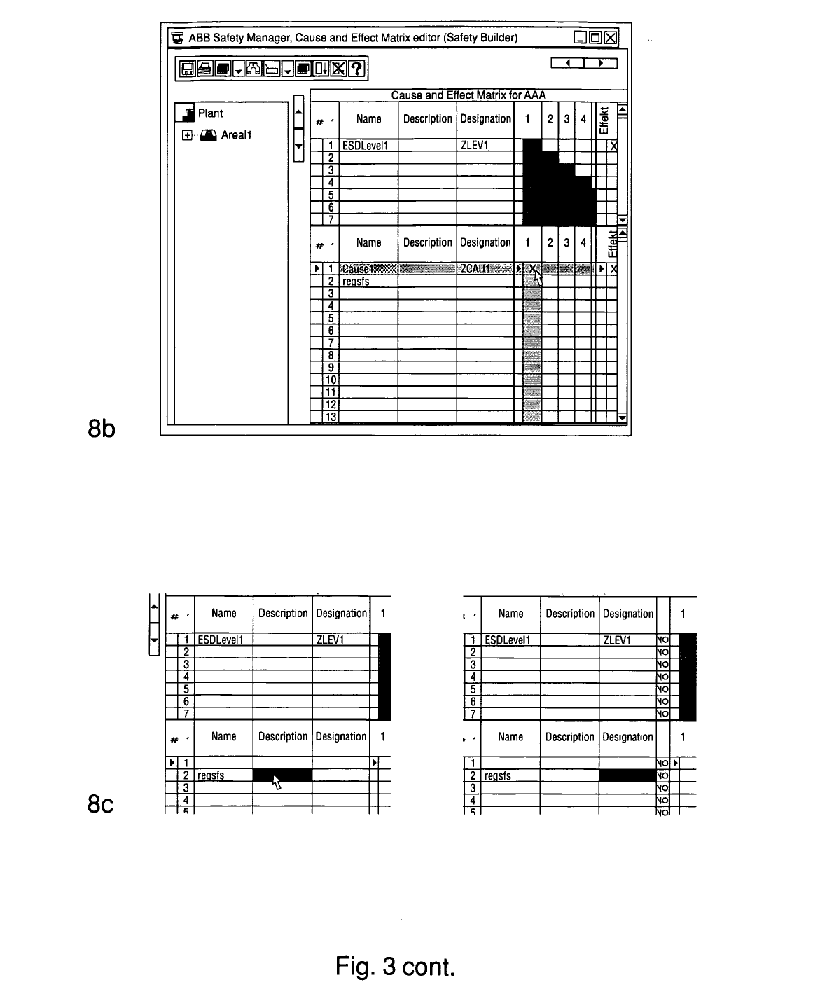

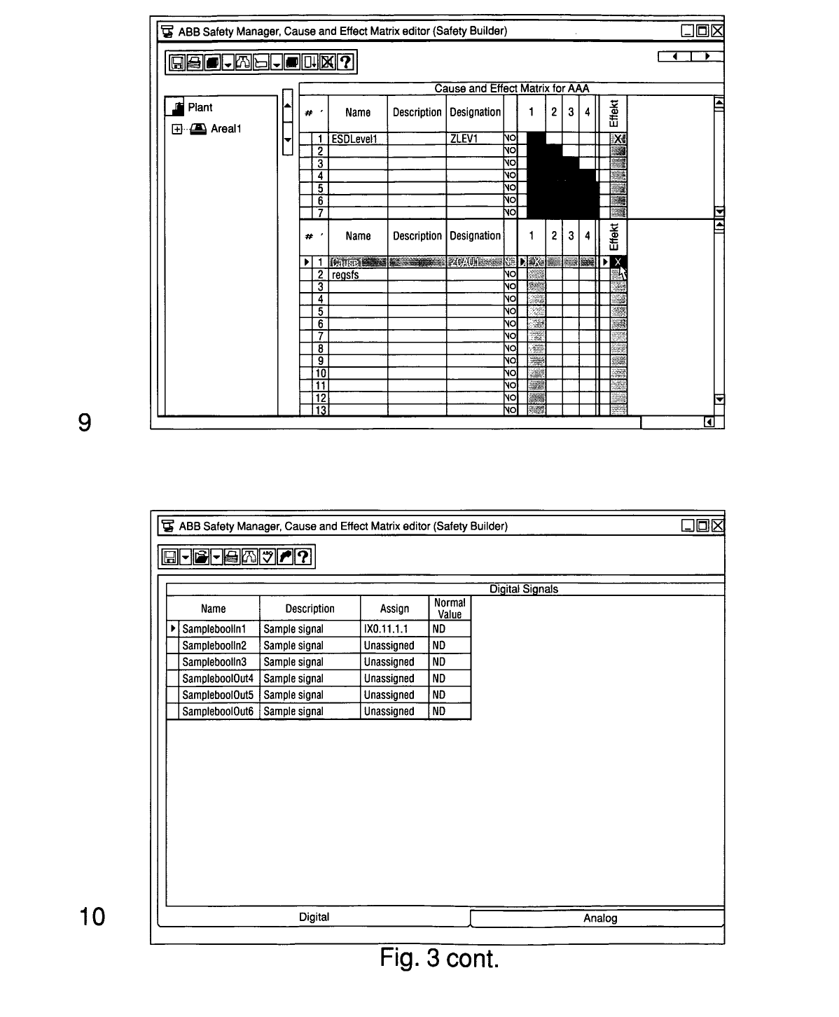

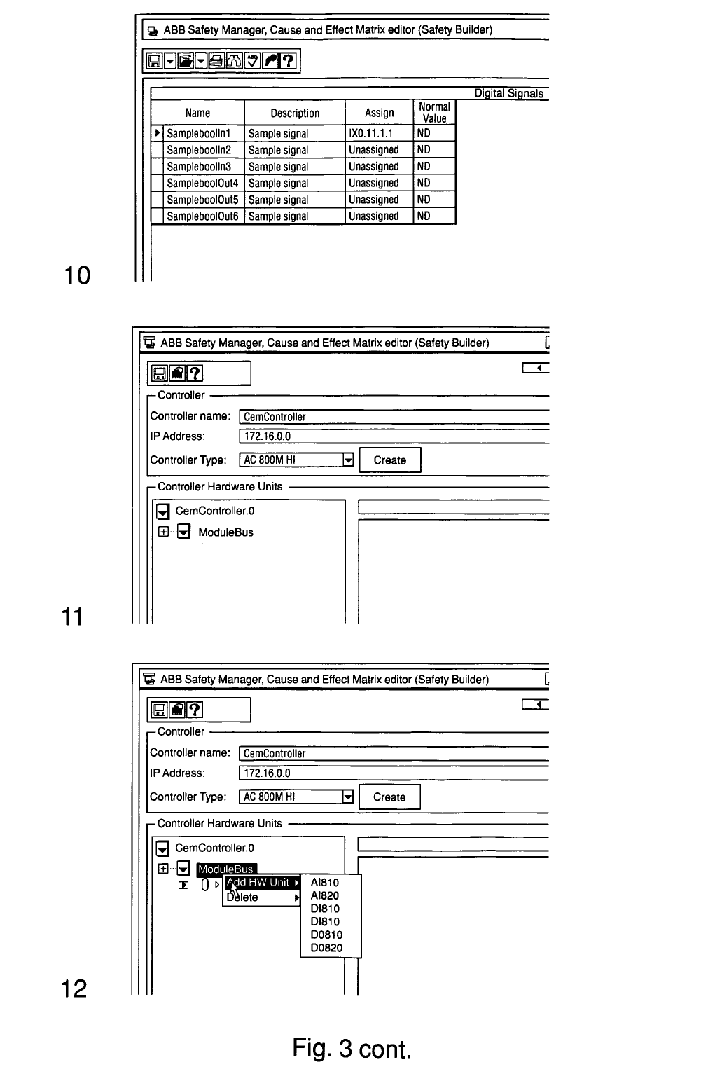

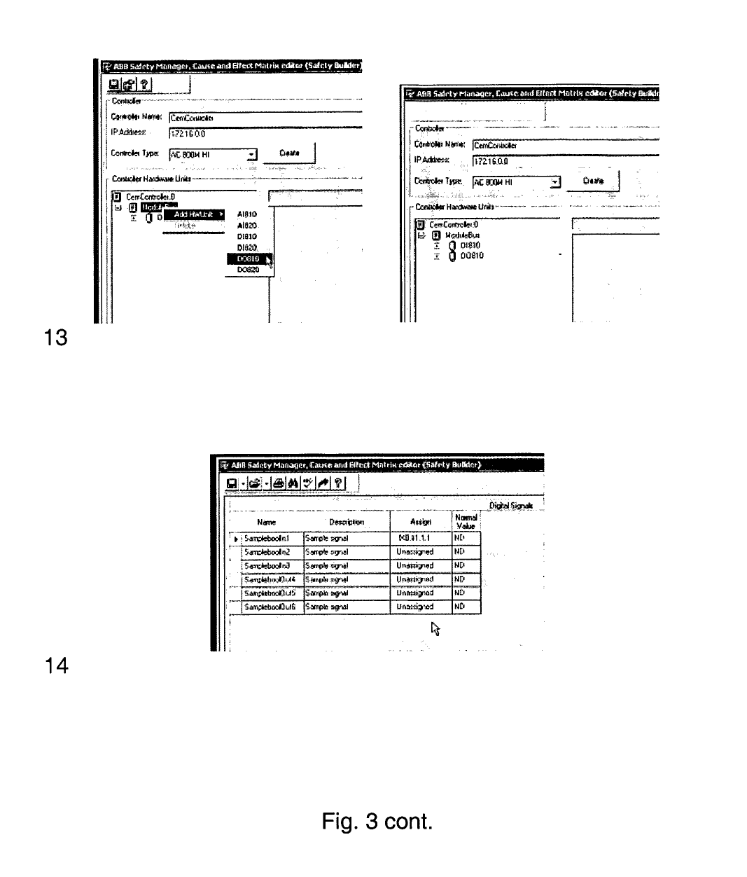

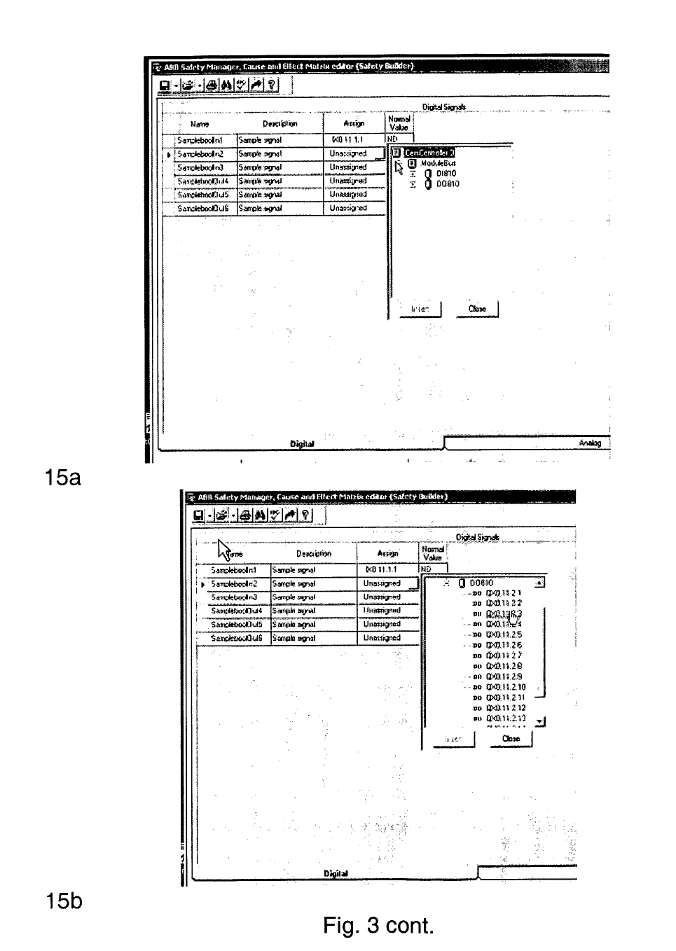

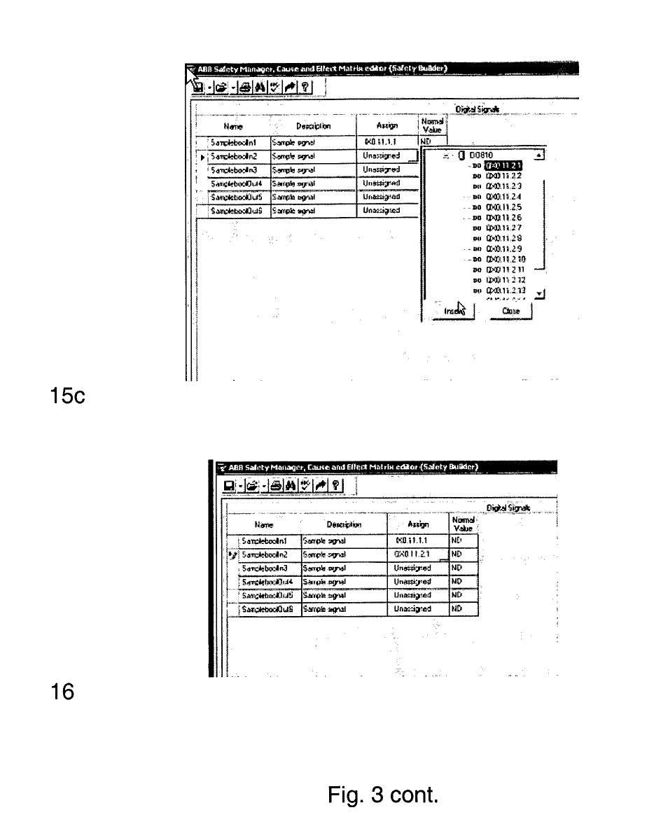

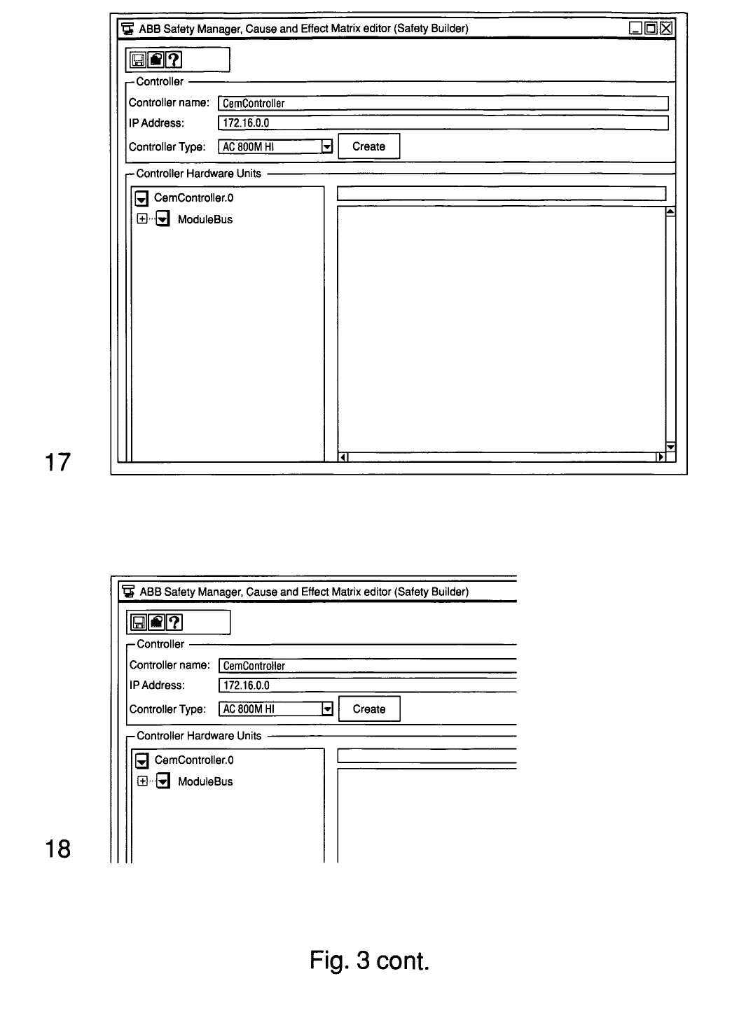

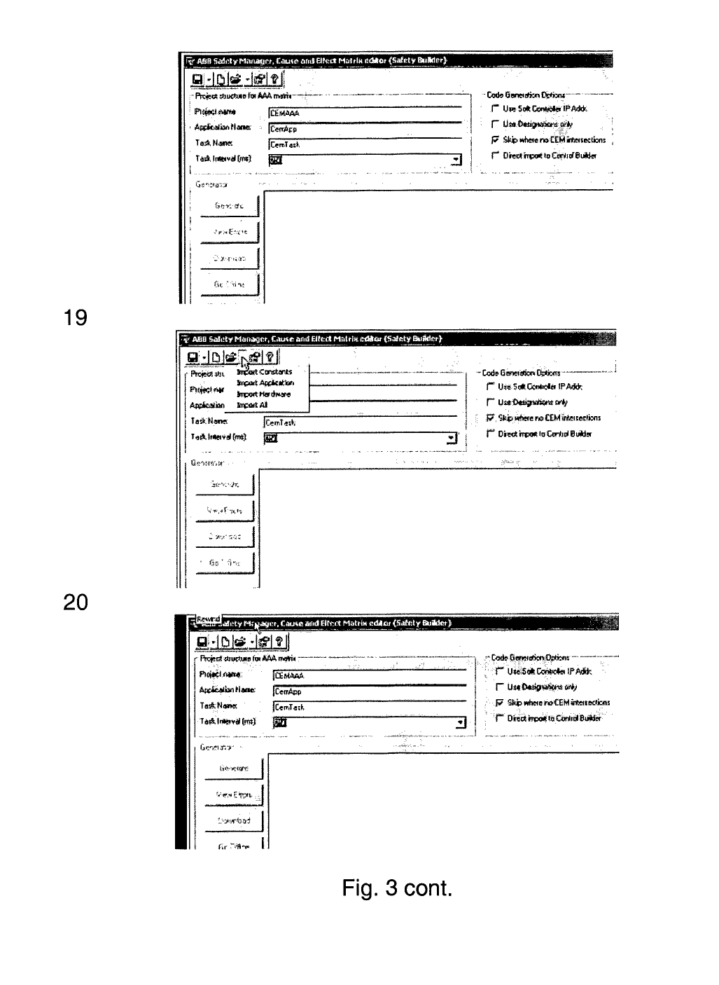

FIG. 3 shows a method by which safety data are saved according to the invention. The user input is, for instance, carried out by means of mouse clicks on images of elements or other selection devices displayed on a suitable computer screen. The generation of the control-code is made with a click on the generation button. The code for the controller also generates the control system and the display system.

The user input can also be a touch-screen. Another user input could also be voice- or hand-motion generated.
1. Identification of user. For example, only technicians have access to the safety system.
2. Select matrix. Open the matrix.
3. Select a plant, Plant, wherein each plant represents a physical process. Each plant is divided into areas corresponding to a physical area. Open the plant.
4. Select an area. Open the area. In each area, a predefined matrix is created. The rows represent causes and the columns represent effects in the plants. The columns are text, for instance: name, description, designation effects, and levels. The rows are text, for instance:
5a. Create a new device entry. Select Cause, Effect, Level, Block, Reset or Area.
5b. There are different user-friendly display options, such as show all, levels only and hide levels.
5c. There are different user-friendly signal options, such as show signals, hide signals and collapse signals.
6. Select a process device. The first criterion are the parameters what name and what cause.

Each cause has the following positions/parameters:

A name, that means a specific identification of the object.

A description, which is what kind of devices that is represented such as a motor.

A designation, that is if the device is designated or not.

A level, that is what size of the area, part of the process, will be affected by the alarm.

An effect, that is what action, will be taken in the plant according to the alarm signal, for instance, a shutdown.
7a. Each cause has a display for parameter input, variables, such as Name, Designation, Area, Description, Action, Delay. The delay specifies the duration of an alarm before an action is taken. Each position in the name corresponds to an object in the plant. Select an object and open the display.
7b. Each variable has a number of available signals.

Each signal has the following parameters/positions:

A name, which is an identification of that signal.

A description, that is what kind of signal it is.

An assign, that is if the signal is assigned or not.

A normal, the signal in normal mode.
7c Different user-friendly options such as show available signals, and hide available signals.
8a. Select a level. Each level is connected to an object, with name, description and designation.
8b. Each level effects a predefined number of row positions. Each level corresponds to a predefined set of objects in the plant. This set of objects will be affected of a predefined action that is to be taken upon receipt of an alarm signal from the object corresponding to the name in that row. The signal is due to a predefined event.
8c. Select a description. Select a designation
9. Select an effect. Each effect is connected to a level. Open the effect.
10. Each effect has a display that shows signals, digital signals and analogue signals. Each signal has a number of parameters.

Each digital and analogue signal has the following parameters/positions:

A name, which is an identification of that signal.

A description, which is what kind of signal it is.

An assign, that is if the signal is assigned or not.

A normal, the value of the signal in normal mode.

The same procedure is valid for digital signals as well as analogue signals.
11. Select a control object, a controller. Open the controller.
12. Select a fieldbus. Open the fieldbus.
13. Select an input channel. Open the input channel.
14. Open the signal display.
15a. Assign the input. Select the controller.
15b. Select the input channel.
15c. Select the input.
16. The assignation is ready.
17. Open a project. Each project has a structure, here represented as a matrix. In this application, which COM controller is to be used in the plant. Task name and task interval is specified.
18. The options for the matrix so made are to:

Export the constants, export the application, export the hardware, and export all.

Import the constants, import the application, import the hardware, and import all.
19. The options for the matrix so made are to:

Export the constants, export the application, export the hardware, and export all.

Import the constants, import the application, import the hardware, and import all.
20. Skip where no CEM intersections.

In parallel with the generated control logic (which runs in a safety controller), the corresponding operator display screens are auto-generated. In the example above, the screen will show the cause (a pressure transmitter input) as a row, the level (the process shutdown) and the effect (the shutoff valve) as columns, properly labelled and positioned as in the editor. Most importantly, these graphic elements are atomically subscribed to real-time data coming from the auto-generated code, exactly as the system would perform in the field. This combination of controller logic and display provides a more complete and faithful environment for testing the solution. In parallel with the generated control logic (which runs in a safety controller), the corresponding operator display screens are auto-generated. In the example above, the screen will show the cause (a pressure transmitter input) as a row, the level (the process shutdown) and the effect (the shutoff valve) as columns, properly labelled and positioned as in the editor. Most importantly, these graphic elements are atomically subscribed to real-time data coming from the auto-generated code, exactly as the system would perform in the field. This combination of controller logic and display provides a more complete and faithful environment for testing the solution.

A typical signal may be, for example, a warning for high pressure.

Operator display may be designed in that colours may be used to indicate the status, for example, green means true, red means off, yellow means active or other colours and meanings.

The displays are the operator screen. Data, such as for example safety data, are comprised in the display and also in the elements in the system. All of this data made available according to the present invention, at the HMI interface, the displays on the screen on the apparatus and/or via a data interface of the element to a computer, either by direct connection to the apparatus or via a data network that the element is connected to. In this way, the relevant safety data is captured and made available for monitoring and analysis by an operator or even by a computerised process. The display shows real-time values.

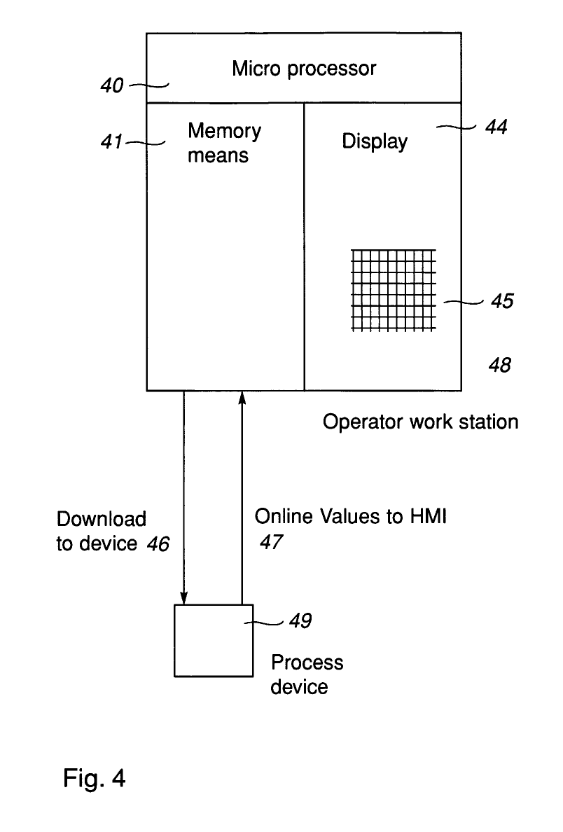

FIG. 4 shows elements of a safety system in a simplified block diagram. Within the operator work station 48, a microprocessor 40 is shown and a memory means 41. Selections made by a selection means embodied as a mark or icon 45, in the grid/matrix in the display 44, corresponding to means or in other forms are registered with the microprocessor and stored if relevant in a working memory and/or in a long term storage memory. The functions displayed at the time of selections being made are also displayed by means of the microprocessor; so that the selection options available are provided on display means by program means run by the microprocessor and the selection options actually made are saved in the memory means. After validation on the operator work station, the auto-generated code is downloaded 46 via an engineering tool to the process device 49 which controls the safety process. When operating normally, online values from the safety process 47 are made available in the grid/matrix in the display 44 of the operator work station via a field bus network and server arrangement.

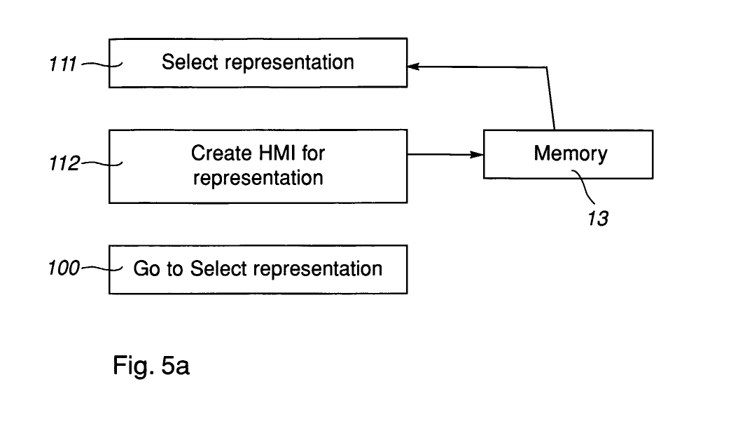

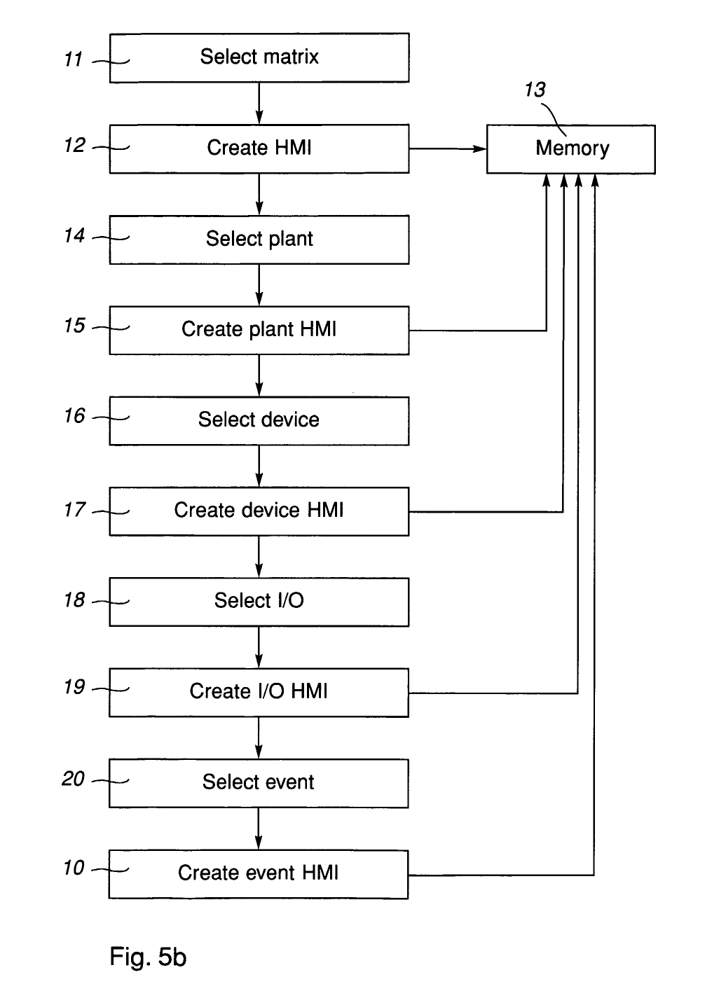

FIG. 5a shows a meta-loop in a safety system in a simplified block diagram. A computer data representation is selected (111). A HMI for said computer data representation is created (112), preferably as a table including preferred items. The paths between the computer data representation and the preferred items are stored in the memory (113). The process continues on another level and a new computer data representation is selected (100.)

FIG. 5b shows a detailed loop in a safety system in a simplified block diagram. A computer data representation for a matrix is selected (11). A HMI for said computer data representation for a matrix s created (12). The paths between the computer data representation and the preferred items are stored in the memory (13). A computer data representation for a plant is selected (14). A HMI for said computer data representation for a plant is created (15). The paths between the computer data representation and the preferred items are stored in the memory (13). A computer data representation for a device is selected (16). A HMI for said computer data representation for a device is created (17). The paths between the computer data representation and the preferred items are stored in the memory (13). A computer data representation for an I/O (input/output) is selected (18). A HMI for said computer data representation for an I/O is created (19). The paths between the computer data representation and the preferred items are stored in the memory (13). A computer data representation for an event is selected (20). A HMI for said computer data representation for an event is created (10). The paths between the computer data representation and the preferred items are stored in the memory (13).

Display of the operations and configuration safety data of one or more of the devices in the system controlled by a safety means is displayed and examined using the HMI of the selected device.

However the same data input display schemes are carried out using a computer or similar connected to the element.

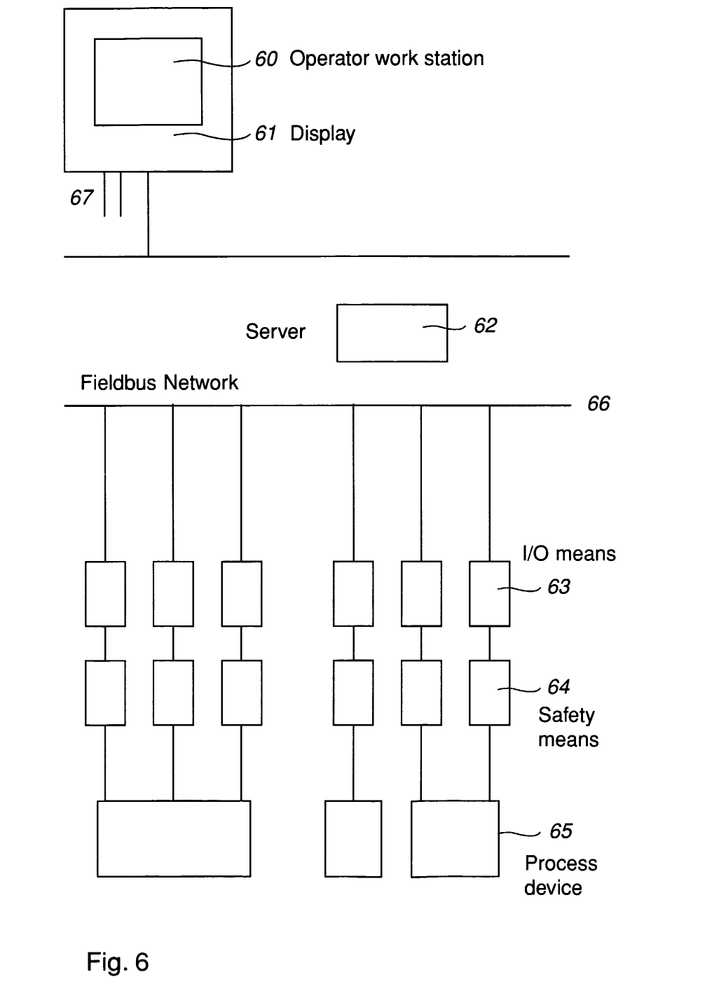

FIG. 6 shows in a schematic way how one process device 65 or more devices are connected via a field bus network 66 of a safety system. FIG. 6 shows a data network of a safety system a server 62 and a computer or workstation 60 connected to the safety system. The safety system comprises a bank of safety devices 64 with (input/output) I/O means and a field bus to which the devices according to the invention are connected for digital exchange of data between the safety devices and the safety system. FIG. 6 shows two data ports 67. In FIG. 6, the first data port represents a standard serial data port and the second data port represents another data port configured to any data any communication protocol. The display 61 is, for example, preferably an LCD, Liquid Crystal Display. Another embodiment is including sensitive screen materials, touch screens and the like.

In a yet further embodiment of the invention, the HMI of the safety system may be embodied as a touch screen. In this case, text lines or images included in the display of the preferred embodiment, and the select, navigation buttons may each be embodied as images on a touch screen. Monitoring of the operations of one or more of process devices protected by a safety means may be carried out according to the same method but executed by means of touching parts of the screen instead of pressing buttons, or by clicking with a computer mouse or other pointing/selection device.

In particular, this invention applies to the auto generation of plant shutdown logic and operator screens via a cause-and-effect matrix approach (CEM). The CEM editor is used during the design phase to specify detection and action linkages such as a pressure switch triggering an emergency shut-off valve and a process-shutdown signal.

This and more processes including any of the one or more process devices that are being protected by a safety device and a HMI according to the invention are being monitored. Thus monitoring of many processes are being carried out without the use of extra sensors to measure safety data.

A industrial safety system comprises components with inputs and safety devices enabling signals to be generated as a result of an event or alarm A system for controlling a process or equipment in a industrial safety system according to the invention may comprise components from any of the list of: a computer such as a tablet personal computer PC, a computer program and a graphical user interface.

The graphical user interface may also be displayed on a hand-held device displaying, said hand-held device comprising input means.

The communications from the safety device via a data network also comprise a computer data signal in another aspect of the invention. The computer data signal is for monitoring and/or safety protection arranged to provide safety protection to one or more process devices embodied in a carrier wave. The data signal complies with one of more formats, for example internally formatted as an XML file, and includes means to identify the sending elements and the type of data such as saved events, saved alarms, configured overload protection etc. for said device.

The data obtained from the device are analysed by any suitable statistical or modelling or simulation method.

The microprocessor, or processors, of device including the safety means, comprises at least one central processing unit CPU performing the steps of the method according to an aspect of the invention. This is performed with the aid of one or more computer programs, which are stored at least in part in memory accessible by the processor. It is to be understood that the computer programs are also being run on one or more general-purpose industrial microprocessors or computers instead of a specially adapted computer.

The computer program comprises computer program code elements or software code portions that make the computer perform the method using equations, algorithms, data and calculations previously described. A part of the program may be stored in a processor as above, but also in an ROM, RAM, PROM, EPROM or EEPROM chip or similar memory means. The program in part or in whole may also be stored on, or in, another suitable computer-readable medium such as a magnetic disc, CD-ROM or DVD disk, hard disk, magneto-optical disk, CD-ROM or DVD disk, hard disk, magneto-optical memory storage means, in volatile memory, in flash memory, as firmware, or stored on a data server. Removable memory media such as removable hard drives, bubble memory device, flash memory devices and commercially available proprietary removable media such as the Sony memory stick and memory cards for digital cameras, video cameras and the like may also be used.

The computer programs described may also be arranged in part as a distributed application capable of running on several computers or computer systems at more or less the same time.

A database may also contain information to be used in a method in an industrial safety system for controlling a process or equipment, according to the invention.

A website may also comprise client/server means to perform a method in an industrial safety system for controlling a process or equipment, according to the invention.

A data communication signal may also be used for controlling at least one component in an industrial facility for an industrial process. The data communication signal comprises safety information for controlling a process or equipment in an industrial safety system such as other signals generated as a result of an event or alarm.

This invention is applicable in all industrial areas where safety systems are mandated and other areas where introducing mandatory safety system is under discussion.

1. A method in an industrial safety system for controlling a process or equipment, the industrial safety system comprises components with safety devices, wherein the safety system enables signals to be generated as a result of an event or alarm, the method comprising:
creating an automated link between the event or alarm and an action to be taken upon receipt of said event or alarm signal due to the event, and
generating a control signal to initiate the action.

2. The method according to claim 1, further comprising:
configuring a representation of a safety device, and
configuring a representation of said event or alarm.

3. The method according to claim 1, further comprising:
creating a schematic representation of the safety system comprising the components and the safety devices, and
creating a representation of each component.

4. The method according to claim 1, further comprising:
creating a representation of each safety device.

5. The method according to claim 1, further comprising:
creating a representation of each input, and
creating a representation of each output.

6. The method according to claim 1, further comprising:
creating a representation of each action, and
creating a representation of each event.

7. The method according to claim 1, further comprising:
configuring one or more links comprising a link between the event and the input, comprising a path between the input and the safety device, a path between the safety device and output, and a path between the output and the action.

8. The method according to claim 1, further comprising:
displaying the link by means of a representation in a human machine interface.

9. The method according to claim 1, further comprising:
displaying the link by means of a representation in a graphical user interface on a screen.

10. The method according to claim 1, wherein each path is represented by a table.

11. The method according to claim 1, wherein each table is displayed in a graphical user interface on a screen.

12. The method according to claim 1, wherein relations between the representations are displayed in the form of a matrix.

13. A computerized industrial system, comprising:
means to perform a method in an industrial safety system for controlling a process or equipment, according to claim 1.

14. A computer program product, comprising
a computer readable medium; and
programming instructions recorded on the computer readable medium to control a computer or a computer process to make it perform a method in an industrial safety system for controlling a process or equipment including
creating an automated link between the event or alarm and an action to be taken upon receipt of said event or alarm signal due to the event, and
generating a control signal to initiate the action.

15. Use of a computer program according to claim 14 to control a computer or a computer process to make it perform a method in an industrial safety system for controlling a process or equipment.

16. (canceled)

17. A graphical user interface for controlling a process or equipment in an industrial safety system, the industrial safety system comprising components with safety devices, that enables signals to be generated as a result of an event or alarm, the graphical user interface comprising:
display means to display a representation of an item,
display means to display relations between the items, and
input means to register said items and relations.

18. The graphical user interface according to claim 17, further comprising:
input means to register an alarm signal or an event,
input means to register an input to a safety device

19. The graphical user interface according to claim 17, further comprising:
display means to register an input signal, and
display means to register an output signal.

20. The graphical user interface according to claim 17, further comprising:
input means to register a path.

21. The graphical user interface according to claim 17, further comprising:
display means for creating a matrix.

22. A system for controlling a process or equipment in an industrial safety system, the industrial safety system comprises components with inputs and safety devices enabling signals to be generated as a result of an event or alarm, the system comprising:
components from any of the list of: a computer such as a tablet personal computer PC, a computer program and a graphical user interface.

23. The system according to claim 22, further comprising:
a hand-held device displaying said graphical user interface, and
input means to said hand-held device.

24. A computerized industrial system, comprising:
means to perform a method in an industrial safety system for controlling a process or equipment, according to claim 1.

25. A database, comprising:
information to be used in a method in an industrial safety system for controlling a process or equipment, according to claim 1.

26. A website, comprising:
means to perform a method in an industrial safety system for controlling a process or equipment, according to claim 1.

27. A data communication signal for controlling at least one component in a an industrial facility for an industrial process, the data communication signal comprising:
safety information for controlling a process or equipment in a industrial safety system such as a signals generated as a result of an event or alarm.
